(19) United States
(12) Patent Application Publication
(10) Pub. No.: US 2022/0190655 A1
(43) Pub. Date: Jun. 16, 2022

(54) Electric Machine with Torque Support in the Housing

(71) Applicant: ZF Friedrichshafen AG, Friedrichshafen (DE)

(72) Inventors: Timo Wehlen, Friedrichshafen (DE); Eckhardt Lübke, Friedrichshafen (DE); Andreas Hölscher, Uhldingen-Mühlhofen (DE); Martin Jelinewski, Nonnenhorn (DE); Manfred Till, Friedrichshafen (DE); Ulrich Kehr, Tettnang (DE)

(21) Appl. No.: 17/603,088

(22) PCT Filed: Mar. 4, 2020
(86) PCT No.: PCT/EP2020/055635

§ 371 Date: Oct. 12, 2021

(30) Foreign Application Priority Data
Apr. 23, 2019 (DE) 10 2019 205 762.4

(51) Int. Cl. H02K 1/18; H02K 1/20

(52) U.S. Cl. CPC H02K 1/185; H02K 1/20

(57) ABSTRACT

An electric machine (1) may include a multi-piece housing (2) including a first housing end-face section (2a), a second housing end-face section (2b), and a housing shell section (2c) axially between the first and second housing end-face sections (2a, 2b). The electric machine (1) may further include a stator (4) fixed relative to the housing (2) proximate at least one of the first and second housing end-face sections (2a, 2b). Additionally, the electric machine (1) may include a rotor (5) radially within the stator (4). At least one of the first and second housing end-face sections (2a, 2b) has at least one axial ridge (14a) protruding axially into the stator (4) and rotationally fixed to an inner circumferential surface (15) of the stator (4) to support torque of the stator (4).

### CROSS-REFERENCE TO RELATED APPLICATION

The present application is related and has right of priority to German Patent Application No. 10 2019 205 762.4 filed on Apr. 23, 2019 and is a nationalization of PCT/EP2020/055635 filed in the European Patent Office on Mar. 4, 2020, both of which are incorporated by reference in their entirety for all purposes.

### FIELD OF THE INVENTION

The invention relates generally to an electric machine including a multi-piece housing, a stator stationarily accommodated at the housing, and a rotor arranged radially within the stator.

### BACKGROUND

DE 10 2013 201 758 A1 describes an electric machine having a housing and a stator accommodated at the housing, a rotor arranged radially within the stator, and a cooling device between the stator and the housing. A torque of the stator is supported with respect to the housing by torque support elements.

### SUMMARY OF THE INVENTION

The problem addressed by example aspects of the present invention is that of creating an electric machine having an alternative torque support.

An electric machine according to the invention includes a housing formed as multiple housing pieces, including a first housing end-face section, a second housing end-face section, and a housing shell section arranged axially between the first and second housing end-face sections. The electric machine further includes a stator, stationarily accommodated proximate at least one of the two housing end-face sections, and a rotor, arranged radially within the stator. At least one of the two housing end-face sections has at least one axial ridge, which, for the torque support of the stator, protrudes axially into the stator and is rotationally fixed to an inner circumferential surface of the stator.

In other words, at least one axial ridge is formed at the first housing end-face section, at least one axial ridge is formed at the second housing end-face section, or at least one axial ridge is formed at each of the two housing end-face sections. An “axial ridge” is a molding at the housing end-face section formed essentially axially in the direction of the stator, and which protrudes radially inwardly towards the stator, resting against the inner circumferential surface of the stator. As such, the axial ridge implements a rotationally fixed connection between the stator and the housing such that the stator is stationary or fixed relative to the housing and, associated therewith, to support a torque of the stator. This yields a cost-effective and installation space-neutral torque support of the stator, which is particularly reliable and robust. The particular housing end-face section is rotationally fixed to the housing shell section. In particular, multiple axial ridges are formed proximate at least one of the two housing end-face sections. Due to the at least one axial ridge, further stator carriers for the torque support of the stator are obsolete.

The housing shell section is essentially a hollow cylinder and is configured for completely accommodating or radially surrounding the stator. The particular housing end-face section is provided for coming to rest at least against the housing shell section and, optionally, also against the stator in order to delimit the housing in the axial direction. In particular, at least one of the two housing end-face sections is a housing cover.

Preferably, the at least one axial ridge form-lockingly engages into at least one winding groove at the inner circumferential surface of the stator. The stator has, at the inner circumferential surface, a plurality of winding grooves which extend in a straight line in the axial direction and evenly distributed adjacent to one another in the circumferential direction. In particular, the stator is made up of multiple stator modules connected to one another, which form winding grooves, into which stator windings are introduced. Consequently, the stator requires no modification in order to form a form-locking connection, and so only the at least one axial ridge is corresponding or complementary to the at least one winding groove at the stator.

Preferably, the at least one axial ridge is formed circumferentially proximate at least one of the two housing end-face sections and has an external toothing engaging into multiple winding grooves. Consequently, the winding grooves at the inner circumferential surface of the stator act as an internal toothing for the form-locking connection to the external toothing of the at least one axial ridge, which is circumferentially formed. An external toothing is understood to be multiple radially outwardly directed shaped elements, which are corresponding or complementary to the winding grooves shaped as recesses. The external toothing therefore includes at least two such shaped elements. In particular, the external toothing includes a plurality of shaped elements, which are arranged adjacent to one another in the circumferential direction and form a toothing formed from teeth and tooth gaps arranged in alternation around the entire circumference.

Moreover, the axial ridge is preferably formed proximate at least the first housing end-face section, wherein the first housing end-face section is arranged on the transmission side. Therefore, the electric machine is connected at an end face to a transmission, wherein the first housing end-face section is arranged axially between the electric machine and the transmission. In particular, the first housing end-face section is more robust, for example, having thicker walls, than the second housing end-face section.

According to one preferred embodiment of the invention, a bearing element is at the at least one axial ridge. Preferably, the bearing element is arranged at an axial ridge, which is formed at the second housing end-face section.

According to an example embodiment that further improves the invention, an electrically insulating plastic body radially surrounds at least one soft magnetic core of the stator as well as first and second winding overhangs of the stator at the end faces, and axially surround the first and second winding overhangs. At least one channel, which is provided for accommodating a coolant, is formed in the plastic body. The at least one coolant-guiding channel is provided for efficiently cooling at least the stator of the electric machine. In order to improve the cooling of the electric machine, it is essential to cool the first and second winding overhangs at the end faces and radially on the outside. Moreover, the at least one channel prevents dead water zones and enables an efficient coolant flow.

Consequently, at least the soft magnetic core and the first and second winding overhangs of the stator are encased by the plastic body at the end faces and radially on the outside. In particular, the winding overhangs are completely embedded in the plastic body. Therefore, the stator is preferably completely extrusion-coated with the plastic body except for an inner circumferential surface. The electrically insulating plastic body is preferably manufactured using an injection molding process or is made of a molding compound configured for electrically insulating, sealing off, and cooling—by means of a coolant flow in the at least one channel—the electrically conductive components of the stator.

The stator is formed from the soft magnetic core and windings and is configured for generating an electromagnetic field. The windings are formed, in particular, from copper wires and have winding overhangs at the ends, toward each end face of the stator, namely the first winding overhangs at the first end face, i.e., at a first axial end of the stator, and the second winding overhangs at the other end face, i.e., at a second axial end of the stator. The soft magnetic core of the stator is arranged axially between the first winding overhangs and the second winding overhangs.

For example, a single channel is formed in the plastic body, which extends from the first end of the stator to the second end of the stator. Alternatively, in some embodiments, multiple channels are formed in the plastic body, which extend from the first end of the stator to the second end of the stator.

In particular, a second section of the at least one channel is helically formed along the outer circumferential surface of the stator. Moreover, it is also conceivable, however, that the at least one channel is meandering or curved. In some example embodiments, the at least one channel also includes axial as well as parallel channel sections, or is divided into two half-flows. A combination of the aforementioned forms as well as further arbitrary forms is also conceivable.

For example, a first section of the at least one channel is formed, at least partially circumferentially, along one end face of the first winding overhangs. Furthermore, a second section of the at least one channel is formed, repeatedly circumferentially or helically, along an outer circumferential surface of the stator. Additionally, a third section of the at least one channel is formed, at least partially circumferentially, along one end face of the second winding overhangs.

Due to the cooling of the winding overhangs at the end faces as well as radially on the outside at both ends of the stator and due to the radially outer cooling of the soft magnetic core, a large amount of waste heat is removed via the coolant and the stator is efficiently cooled. As a result, the continuous input power of the electric machine is increased. A typical stator cooling jacket is not necessary, which reduces costs, weight, and installation space. In particular, a noise decoupling between the stator and the housing takes place via the plastic body. Moreover, only a small amount of heat is transferred to a transmission oil of a transmission operatively connected to the electric machine, and so an oil-water heat exchanger is dispensed with. In particular, the electric machine is provided for being connected, at an end face, to the transmission. Due to the cooling at both end faces of the electric machine, a cooling of a transmission wall of a transmission arranged at one end face of the electric machine also takes place.

Preferably, an inflow or inlet for the coolant is formed at the end face of the first winding overhangs, and an outflow or outlet for the coolant is formed at the end face of the second winding overhangs. At the inflow, the coolant has the lowest temperature and, thereby, the highest cooling power, because it has not yet absorbed any waste heat from the stator. Additionally, the temperature at the first winding overhangs during the operation of the electric machine is higher than the temperature at the second winding overhangs. The coolant is preferably water-based. An inflow connection geometry, for example, an inlet opening, and an outflow connection geometry, for example, an outlet opening, is radial or axial, in order to generate installation space advantages. An inflow for the coolant is understood to mean lines or geometries that make it possible for coolant to flow into the at least one channel. Moreover, an outflow for the coolant is understood to mean lines or geometries that make it possible for coolant to flow out of the at least one channel. Moreover, it is advantageous to arrange a transmission at the end face on the side of the outflow, wherein an oil-water heat exchanger abuts the outflow.

Preferably, an axial width of the second section of the at least one channel at the outer circumferential surface of the stator is at least three times as large as a radial depth of the second section of the at least one channel at the outer circumferential surface of the stator. Consequently, the at least one channel is wide and flat at the outer circumferential surface of the stator. For example, the axial width of the second section of the at least one channel at the outer circumferential surface of the stator is five times as large as the radial depth of the second section of the at least one channel at the outer circumferential surface of the stator. This improves, in particular, the cooling of the electric machine.

Moreover, the at least one channel is preferably an indentation in an outer surface of the plastic body and is configured for guiding the coolant between the housing and the plastic body. In particular, the at least one channel is an indentation in both end faces and in a lateral surface of the plastic body. For example, the indentations at the end faces of the plastic body are fluidically connected to each other by bore holes or recesses in the plastic body.

Preferably, the at least one channel is formed along at least one electrical line, the at least one electrical line conducting an electric current between a power electronics unit of the electric machine and the stator. In particular, the at least one channel is guided—at least partially or completely—along all electrical lines that are connected to the stator in order to cool the stator. Preferably, the at least one electrical line is a copper rail, a copper wire, or a flat copper component. In particular, the electric machine is a 3-phase motor (UVW motor) and is provided for use as a prime mover for a motor vehicle, and so three electrical lines are provided with alternating current for operating the electric machine. A power electronics unit is understood to be a device that controls the operation, in particular the energization, of the stator by an open-loop system and a closed-loop system. In particular, the power electronics unit includes an inverter, which is configured for converting DC voltage into AC voltage.

Preferably, the at least one channel at the first winding overhangs has a larger volume for coolant than the at least one channel at the second winding overhangs. In particular, the electrical lines are arranged at the first winding overhangs, and so a higher cooling power is generated there by the larger volume for coolant.

Preferably, the plastic body has thermally conductive fillers. In particular, metallic fillers having a high thermal conductivity, for example, copper or aluminum particles, are arranged in the plastic body such that an electrical insulation of the plastic is maintained. Moreover, the plastic body is also furnished with ceramic particles, for example, with metal oxides, in order to increase the thermal conductivity.

### BRIEF DESCRIPTION OF THE DRAWINGS

One preferred exemplary embodiment of the invention is explained in greater detail in the following with reference to the drawings, in which

FIG. 1 shows a half-section schematic view of an electric machine according to the invention,

FIG. 2 shows a lateral schematic view of the electric machine according to the invention,

FIG. 3 shows a perspective schematic view of a stator of the electric machine according to the invention, surrounded by a plastic body, and

FIG. 4 shows a perspective schematic view of the electric machine according to the invention.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

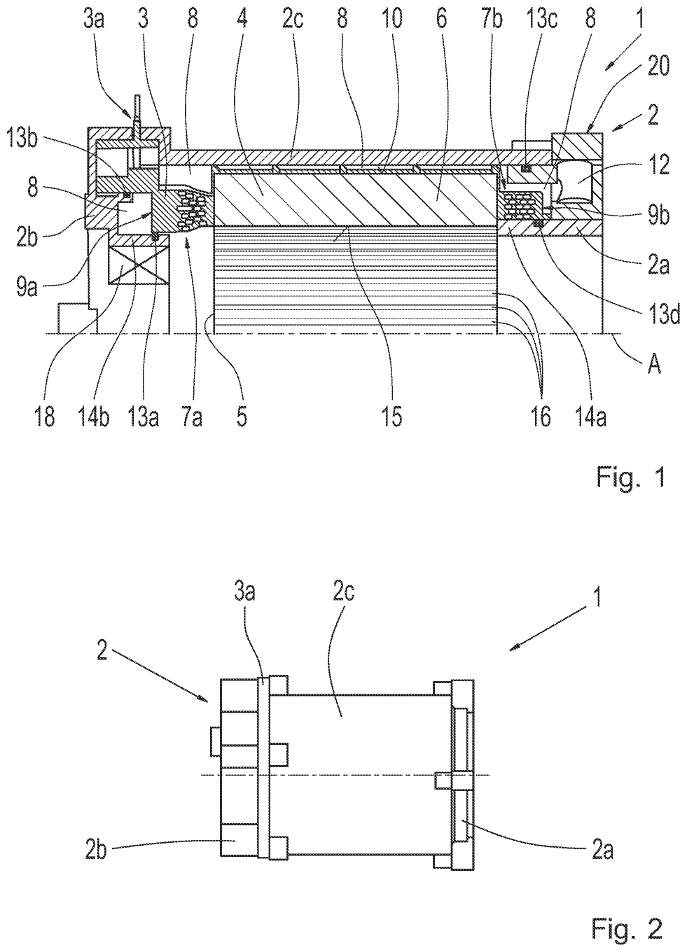

According to FIGS. 1 and 2, an electric machine 1 according to the invention includes a housing 2. The housing 2 is formed as multiple pieces, including a first housing end-face section 2a, a second housing end-face section 2b, and a housing shell section 2c arranged axially between the first and second housing end-face sections 2a, 2b.

According to FIG. 1, the electric machine includes a stator 4, a rotor 5, and an electrically insulating plastic body 3 in the housing 2 of the electric machine 1. The rotor 5 is radially within the stator 4 and is rotatable about an axis of rotation A. The rotor 5 is transparently represented in FIG. 1. A channel 8 is formed in the plastic body 3, a flow of coolant passes through the channel 8 in order to cool the stator 4. The plastic body 3 has thermally conductive fillers in order to increase its thermal conductivity.

The plastic body 3 surrounds a soft magnetic core 6 of the stator 4 at the end faces and radially on the outside. Moreover, the plastic body 3 also surrounds first and second winding overhangs 7a, 7b of the stator 4 at the end faces and radially. In the present case, the plastic body 3 is one piece formed by injection molding. Via the plastic body 3, the electrical parts of the stator 4 are insulated by the plastic body 8 and simultaneously cooled via the coolant (not represented here) guided in the channel 8 formed in the plastic body 3. A first section of the channel 8 at the first winding overhangs 7a has a larger volume for coolant than a section of the channel 8 at the second winding overhangs 7b. An axial width of a second section of the channel 8 at the outer circumferential surface 10 of the stator 4 is approximately six times as great as a radial depth of the second section of the channel 8 at the outer circumferential surface 10 of the stator 4. The channel 8 is an indentation in an outer surface of the plastic body 3 and is configured for guiding the coolant between the housing 2 and the plastic body 3.

The housing end-face sections 2a, 2b each have a respective axial ridge 14a, 14b. The axial ridges 14a, 14b are formed axially in the direction of the stator 4. A first axial ridge 14a is formed at the first housing end-face section 2a, wherein the first housing end-face section 2a is arranged on the transmission side. The first axial ridge 14a protrudes axially into the stator 4 for support of the torque of the stator 4 and is rotationally fixed to an inner circumferential surface 15 of the stator 4. In the present case, the first axial ridge 14a is formed integrally and circumferentially at the first housing end-face section 2a and form-lockingly engages into winding grooves 16 at the inner circumferential surface 15 of the stator 4. For this purpose, a circumferential external toothing is formed at the first axial ridge 14a, which corresponds to the winding grooves 16.

The plastic body 3 is arranged, in the area of the first winding overhangs 7a, radially at or outside of the second axial ridge 14b, which is formed integrally and circumferentially at the second housing end-face section 2b. A first seal 13a is arranged in a groove of the second axial ridge 14b and sealingly comes to rest against the plastic body 3 at the first winding overhangs 7a. A second seal 13b is arranged in a further groove of the second housing end-face section 2b and sealingly comes to rest against the plastic body 3 in an area ahead of or closer to an axial end of the electric machine 1 than the first winding overhangs 7a. Moreover, a third seal 13c is arranged between the first housing end-face section 2a and the housing shell section 2c, wherein the third seal 13c is arranged in a groove of the first housing end-face section 2a and sealingly comes to rest against the plastic body 3. A fourth seal 13d is arranged in a groove of the first axial ridge 14a and sealingly comes to rest against the plastic body 3 at the second winding overhangs 7b. As is particularly apparent from FIG. 2, a section 3a of the plastic body 3 is axially between the second housing end-face section 2b and the housing shell section 2c.

The above-described arrangement of the four seals 13a, 13b, 13c, 13d and the design of the section 3a of the plastic body 3, between the second housing end-face section 2b and the housing shell section 2c, enable a simplified assembly of the electric machine 1 as well as a tolerance compensation in the axial direction, in particular during thermal expansions. Moreover, a bearing element 18 is accommodated at the second housing end-face section 2b at the second axial ridge 14b such that the bearing element 18 is cooled via the section of the channel 8 guided, at the end face, along the first winding overhangs 7a.

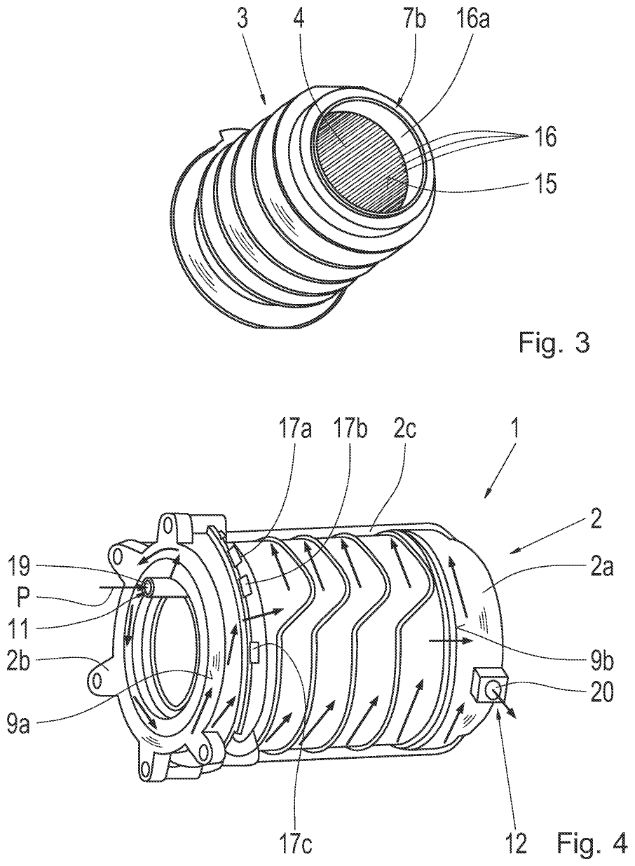

In FIG. 3, a perspective view of the stator 4 and the plastic body 3 is represented, particularly illustrating the area at the second winding overhangs 7b. From this perspective, the winding grooves 16 at the inner circumferential surface of the stator 4 are particularly well visible. The winding grooves 16 are straight lines and are arranged adjacent to one another in the circumferential direction and are evenly distributed at the inner circumferential surface 15 of the stator 4. Consequently, the winding grooves 16 extend in the axial direction. The plastic body 3 is smooth at an inner circumferential surface at the second winding overhangs 7b and is utilized for sealing with respect to the first housing end-face section 2a and for centering and axially guiding the first housing end-face section 2a in the stator 4.

In FIG. 4, a perspective view of the electric machine 1 is represented, wherein the housing shell section 2c is transparently represented. Moreover, a coolant flow is represented by multiple arrows P in a simplified manner. In the present case, an inflow or inlet 11 for the coolant is formed at the end face 9a of the first winding overhangs 7a, wherein the coolant flows into the housing 2 via an inlet opening 19 formed axially in the second housing end-face section 2b. An outflow or outlet 12 for the coolant is formed at the end face 9b of the second winding overhangs 7b, wherein the coolant flows out of the housing 2 via an outlet opening 20 formed radially in the first housing end-face section 2a. The outflow 12 and the outlet opening 20 are represented in a cutaway view in FIG. 1.

The channel 8 formed between the housing 2 and the plastic body 3 is utilized for the forced guidance of the coolant from the inlet opening 19 to the outlet opening 20. In the present case, the coolant is guided through a first section of the channel 8 circumferentially along approximately 80% of the end face 9a of the first winding overhangs 7a. The arrows P illustrate that the coolant flows into the channel 8 via the inlet opening 19 and is circumferentially guided in a circle along approximately 290° of the end face 9a of the first winding overhangs 7a. Subsequent thereto, the coolant flows through a second, helically designed section of the channel 8 four times circumferentially along an outer circumferential surface 10 of the stator 4. Finally, the coolant flows through a third section of the channel 8 circumferentially along approximately 95% of the end face 9b of the second winding overhangs 7b and out of the channel 8 via the outlet opening 20. The temperature of the coolant is minimal in the area of the inflow 11 at the first section of the channel 8 at the first winding overhangs 7a, wherein the temperature continuously increases as it flows through the channel 8 and reaches its maximum value in the area of the outflow 12 at the third section of the channel 8 at the second winding overhangs 7b. Consequently, the first winding overhangs 7a are cooled to a greater extent than the second winding overhangs 7b. Moreover, three electrical lines 17a, 17b, 17c are proximate the first winding overhangs 7a, where the electrical lines 17a, 17b, 17c are configured for conducting an electric current between a power electronics unit (not shown) of the electric machine 1 and the stator 4. In the present case, the channel 8 is formed along the electrical lines 17a, 17b, 17c such that the electrical lines 17a, 17b, 17c are efficiently cooled by the coolant flow.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 electric machine
2 housing
2a first housing end-face section
2b second housing end-face section
2c housing shell section
3 plastic body
3a section of the plastic body
4 stator
5 rotor
6 soft magnetic core
7a first winding overhangs
7b second winding overhangs
8 channel
9a end face of the first winding overhangs
9b end face of the second winding overhangs
10 outer circumferential surface
11 inflow
12 outflow
13a first seal
13b second seal
13c third seal
13d fourth seal
14a first axial ridge
14b second axial ridge
15 inner circumferential surface
16 winding groove
17a electrical line
17b electrical line
17c electrical line
18 bearing element
19 inlet opening
20 outlet opening
A axis of rotation
P arrow

1-13: (canceled)

14. An electric machine (1), comprising:
a multi-piece housing (2) including a first housing end-face section (2a), a second housing end-face section (2b), and a housing shell section (2c) axially between the first and second housing end-face sections (2a, 2b);
a stator (4) fixed relative to the housing (2) proximate at least one of the first and second housing end-face sections (2a, 2b); and
a rotor (5) radially within the stator (4),
wherein at least one of the first and second housing end-face sections (2a, 2b) has at least one axial ridge (14a) protruding axially into the stator (4) and rotationally fixed to an inner circumferential surface (15) of the stator (4) to support torque of the stator (4).

15. The electric machine (1) of claim 14, wherein the at least one axial ridge (14a) form-lockingly engages into at least one winding groove (16) of the inner circumferential surface (15) of the stator (4).

16. The electric machine (1) of claim 15, wherein the at least one axial ridge (14a) is formed circumferentially about the at least one of the first and second housing end-face sections (2a, 2b) and has an external toothing that form-lockingly engages into multiple winding grooves (16).

17. The electric machine (1) of claim 15, wherein at least the first housing end-face section (2a) has the at least one axial ridge (14a), wherein the first housing end-face section (2a) is on a transmission side of the electric machine (1).

18. The electric machine (1) of claim 15, wherein a bearing (18) is proximate at least one of the first and second housing end-face sections (2a, 2b).

19. The electric machine (1) of claim 15, wherein a plastic body (3) is electrically insulating and surrounds at least one soft magnetic core (6) of the stator (4), an end face (9a) of first winding overhangs (7a) of the stator (4), and an end face (9b) of second winding overhangs (7b) of the stator (4), and
wherein at least one channel (8) is formed in the plastic body (3) for accommodating a coolant.

20. The electric machine (1) of claim 19, wherein a first section of the at least one channel (8) extends at least partially circumferentially along the end face (9a) of the first winding overhangs (7a),
wherein a second section of the at least one channel (8) extends circumferentially along an outer circumferential surface (10) of the stator (4), and
wherein a third section of the at least one channel (8) extends at least partially circumferentially along the end face (9b) of the second winding overhangs (7b).

21. The electric machine (1) of claim 20, wherein an inflow (11) for the coolant is at the end face (9a) of the first winding overhangs (7a), wherein an outflow (12) for the coolant is at the end face (9b) of the second winding overhangs (7b).

22. The electric machine (1) of claim 20, wherein an axial width of the second section of the at least one channel (8) at the outer circumferential surface (10) of the stator (4) is at least three times larger than a radial depth of the second section of the at least one channel (8) at the outer circumferential surface (10) of the stator (4).

23. The electric machine (1) of claim 20, wherein the first section of the at least one channel (8) at the first winding overhangs (7a) has a larger volume for receiving the coolant than the third section of the at least one channel (8) at the second winding overhangs (7b).

24. The electric machine (1) of claim 20, wherein the second section of the at least one channel (8) extends helically along the outer circumferential surface (10) of the stator (4).

25. The electric machine (1) of claim 19, wherein the at least one channel (8) is an indentation in an outer surface of the plastic body (3) and guides the coolant between the housing (2) and the plastic body (3).

26. The electric machine (1) of claim 19, wherein the at least one channel (8) extends along at least one electrical line (17a, 17b, 17c), the at least one electrical line (17a, 17b, 17c) conducting an electric current to and from the stator (4).
